(19) United States
(12) Patent Application Publication
(10) Pub. No.: US 2013/0011074 A1
(43) Pub. Date: Jan. 10, 2013

(54) IMAGE SIGNAL DECODING DEVICE AND DECODING METHOD THEREOF

(75) Inventors: Minsu JEON, Seoul (KR); Taehyun KIM, Seongnam-si (KR); Jun-shik JEON, Yongin-si (KR)

(73) Assignee: SAMSUNG ELECTRONICS CO., LTD., Suwon-si (KR)

(21) Appl. No.: 13/542,027

(22) Filed: Jul. 5, 2012

(30) Foreign Application Priority Data
Jul. 5, 2011 (KR) 10-2011-0066586

(51) Int. Cl. G06K 9/46

(52) U.S. Cl. 382/233

(57) ABSTRACT

An image signal decoding device includes a memory having a first region storing a buffer flag, a second region storing a buffer list, and a third region formed of a plurality of buffers each storing a decoded image signal; and a codec configured to decode an image signal in response to a decoding request from a host and to store the decoded image signal in one of the plurality of buffers. The buffer flag indicates a usable or not-available state of each of the plurality of buffers, and the buffer list indicates a used or unused state of each of the plurality of buffers. The codec stores the decoded image signal in a buffer which is set to the unused state in the buffer list and to a usable state in the buffer flag.

### CROSS-REFERENCE TO RELATED PATENT APPLICATION

This application claims priority from Korean Patent Application No. 10-2011-0066586 filed Jul. 5, 2011, the contents of which is incorporated herein in its entirety by reference.

### BACKGROUND

1. Field

Exemplary embodiments relate to an image decoding device and a decoding method thereof.

2. Description of the Related Art

There has been an explosive increase in a need for digital image products.

The digital image products may include a digital video disk (DVD), high definition television (HDTV), satellite TV, HD set-top box, Internet video streaming, digital camera and HD video camcorder, video juke box, video communications, security and observation, business automation, etc. Such digital video products may necessitate video compression. The compression-decompression (called codec) algorithm may enable a digital video to be stored and transferred. In general, the video encoding may include MPEG-2, MPEG-4, H.264/AVC, AVS, On2, Real Video, Nancy, Windows media video (MWV), and the like.

A problem associated with digital image processing may be that a large quantity of data is needed to store or transfer original images or uncompressed images.

### SUMMARY

Exemplary embodiments provide an image decoding device and a decoding method thereof.

According to an aspect of an exemplary embodiment, there is provided an image signal decoding device which includes a memory including a first region storing a buffer flag, a second region storing a buffer list, and a third region formed of a plurality of buffers each storing a decoded image signal; and a codec configured to decode an image signal in response to a decoding request from a host and to store the decoded image signal in one of the plurality of buffers. The buffer flag indicates a usable or not-available state of each of the plurality of buffers, and the buffer list indicates a used or unused state of each of the plurality of buffers. The codec stores the decoded image signal in a buffer which is set to the unused state in the buffer list and to a usable state in the buffer flag.

The codec may select a buffer set to an unused state in the buffer list in response to the decoding request and stores the decoded image signal in the selected buffer when the selected buffer is set to a usable state in the buffer flag.

The codec may select a new buffer set to an unused state in the buffer list when the selected buffer is set to a not-available state in the buffer flag and may store the decoded image signal in the new buffer when the new buffer is set to a usable state in the buffer flag.

The memory may further include a fourth region configured to store a display buffer list indicating a display order of buffers, each storing the decoded image signal, of the plurality of buffers; and a fifth region configured to store a decoded picture buffer (DPB) list indicating a buffer, storing an image signal of a reference frame, of the plurality of buffers each storing the decoded image signal.

The codec may store the decoded image signal in the selected buffer and register information of the selected buffer at the DPB list when the decoded image signal is an image signal of the reference frame.

A display order of buffers storing the decoded image signal stored in the display buffer list may be deleted in a first-in first-out manner, and the codec may set a buffer corresponding to the deleted display order in the buffer list to an unused state.

The buffer flag stored in the first region of the memory may be set by the host.

According to an aspect of another exemplary embodiment, there is provided an image signal decoding method of a decoding device which includes receiving a decoding request from a host; selecting a buffer set to an unused state in a buffer list in response to the decoding request; judging whether the selected buffer is set to a usable state in a buffer flag; decoding an image signal when the selected buffer is set to a usable state in the buffer flag; and storing the decoded image signal in the selected buffer.

The image signal decoding method may further include selecting a new buffer set to an unused state in the buffer list when the selected buffer is set to a not-available state in a buffer flag; and storing the decoded image signal in the new buffer when the new buffer is set to a usable state in the buffer flag.

The buffer flag and buffer list may be stored in a first and a second region of the memory, respectively, and a buffer may be a third region of the memory.

The memory may further include a fourth region configured to store a display buffer list indicating a display order of buffers, each storing the decoded image signal, of the plurality of buffers; and a fifth region configured to store a decoded picture buffer (DPB) list indicating a buffer, storing an image signal of a reference frame, of the plurality of buffers each storing the decoded image signal.

The image signal decoding method may further include registering information of the selected buffer at the DPB list when the decoded image signal is an image signal of the reference frame after storing of the decoded image signal in the selected buffer.

The image signal decoding method may further include providing a host with information of a buffer storing the decoded image signal according to a display order of the buffers stored in the buffer list.

The image signal decoding method may further include after information of a buffer storing the decoded image signal is provided to the host, setting the buffer provided to the host at the buffer list as an unused state.

According to an aspect of another exemplary embodiment, there is provided an image signal decoding system which includes a memory including a first region storing a buffer flag, a second region storing a buffer list, and a third region formed of a plurality of buffers each storing a decoded image signal; a codec configured to decode an image signal in response to a decoding request from a host and to store the decoded image signal in one of the plurality of buffers; and a display device configured to display the decoded image signal.

The codec may store the decoded image signal in a buffer which is set to the unused state in the buffer list and to a usable state in the buffer flag.

The codec may select a buffer set to an unused state in the buffer list in response to the decoding request and may store the decoded image signal in the selected buffer when the selected buffer is set to a usable state in the buffer flag.

The codec may select a new buffer set to an unused state in the buffer list when the selected buffer is set to a not-available state in the buffer flag and may store the decoded image signal in the new buffer when the new buffer is set to a usable state in the buffer flag.

The memory may further include: a fourth region configured to store a display buffer list indicating a display order of buffers, each storing the decoded image signal, of the plurality of buffers; and a fifth region configured to store a decoded picture buffer (DPB) list indicating a buffer, storing an image signal of a reference frame, of the plurality of buffers each storing the decoded image signal.

The codec may continuously decode a plurality of frames in response to the decoding request from the host, and the display device may sequentially display decoded image signals according to a frame order.

### BRIEF DESCRIPTION OF THE DRAWINGS

Illustrative, non-limiting exemplary embodiments will be more clearly understood from the following detailed description taken in conjunction with the accompanying drawings in which:

FIG. 1 is a block diagram illustrating an image processing system including an image signal decoding device according to an exemplary embodiment;

FIG. 2 is a diagram illustrating a memory of FIG. 1 according to an exemplary embodiment;

FIG. 3 is a diagram for describing a decoding method of an image processing system including an image signal decoding device according to an exemplary embodiment;

FIG. 4 is a diagram for describing a decoding order of a codec according to an exemplary embodiment;

FIGS. 5A, 5B, and 5C are flowcharts for describing an image signal decoding method of a decoding device of FIG. 1 according to an exemplary embodiment;

FIG. 6 is a diagram illustrating a decoded picture buffer list of FIG. 3 according to an exemplary embodiment; and

FIG. 7 is a diagram illustrating a decoding system according to another exemplary embodiment.

### DETAILED DESCRIPTION

The inventive concept is described more fully hereinafter with reference to the accompanying drawings, in which exemplary embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

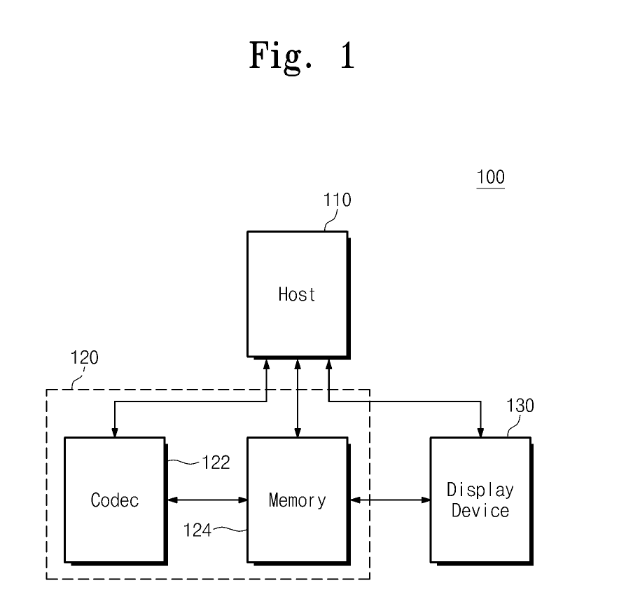

FIG. 1 is a block diagram illustrating an image processing system including an image signal decoding device according to an exemplary embodiment.

Referring to FIG. 1, an image processing system 100 may include a host 110, an image signal decoding device 120, and a display device 130. The host may be, but is not limited to, a computer, processor, microprocessor, microcomputer, or other programmable control device. The host 110 may be configured to control the image signal decoding device 120 and the display device 130. The image signal decoding device 120 may be configured to code and decode an image signal under the control of the host 110. The image signal may be an image signal which is provided from the host or is stored in a memory 124. The image signal decoding device 120 may include a codec 122 and the memory 124. The codec 122 may store a decoded image signal in the memory 124 according to the control of the host 110. The display device 130 may display an image signal stored in the memory 124 under the control of the host 110. The memory 124 may be directly accessed by the codec 122 as well as by the host 110 and the display device 130.

In an exemplary embodiment, the codec 122 and the memory 124 in the image signal decoding device 120 may be separate integrated circuits. In another exemplary embodiment, the codec 122 and the memory 124 may be integrated within a single chip.

The image signal decoding device 120 may be applied to devices, for example but not limited to DVD, HDTV, satellite TV, HD set-top box, Internet video streaming, digital camera and HD video camcorder, video juke box, HD image telephone, digital cinema, digital video broadcasting, IP set-top box, and the like. Further, the inventive concept may be applied to an image signal decoding device complying with various industrial standards such as MPEG2, MPEG4, H.264/AVC, AVS, etc.

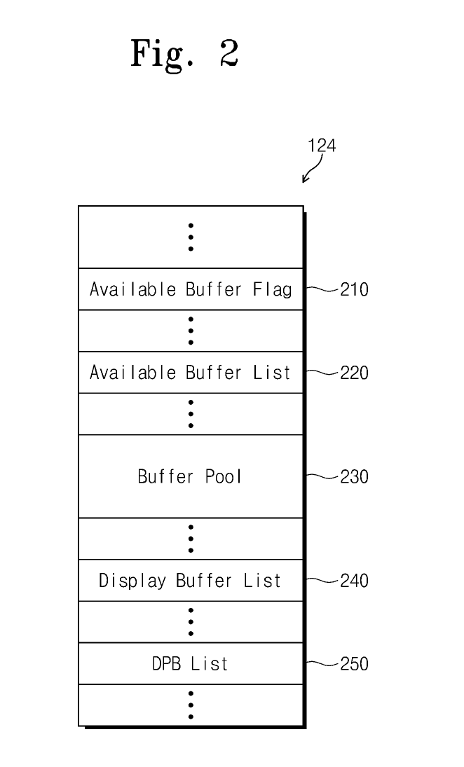

FIG. 2 is a diagram illustrating a memory in FIG. 1 according to an exemplary embodiment.

Referring to FIG. 2, a memory 124 may include the first region 210 storing an available buffer flag, the second region 220 storing an available buffer list, the third region 230 storing a decoded image signal in a buffer pool, the fourth region 240 storing a display buffer list, and the fifth region 250 storing a decoded picture buffer (DPB) list. The first to fifth regions 210 to 250 of the memory 124 may be discontinuous as illustrated in FIG. 2, and their sizes may be determined variously as occasion demands. In order to distinguish the first to fifth regions 210 to 250 explicitly, the first to fifth regions 210 to 250 may be referred to as a buffer flag 210, a buffer list 220, a buffer pool 230, a display buffer list 240, and a DPB list 250, respectively.

Referring to FIGS. 1 and 2, a host 110 may request decoding of an image signal from a codec 122. In an exemplary embodiment, the host 110 may request frame-unit decoding from the codec 122. The codec 122 may decode an image signal stored in a region of the memory 124 or an image signal provided from the host 110, and may store the decoded image signal in the buffer pool 230 of the memory 124. In an exemplary embodiment, the buffer pool 230 may include a plurality of buffers, each of which stores an image signal within a frame.

If receiving information indicating decoding completion from the codec 122, the host 110 may control the display device 130 to read and display a decoded image signal stored in the buffer pool 230 of the memory 124. In a case where the codec 122 continuously decodes a plurality of frames in response to a request of the host 110, the display device 130 sequentially displays decoded image signals according to a frame order. If an image signal of a new frame is overwritten before the display device 130 reads an image signal stored in a buffer within the buffer pool 230, there may arise a tearing error that a screen image is broken.

In an exemplary embodiment, the host 110 may store information indicating whether the codec 122 is usable, in the buffer flag 210, according to whether a decoded image signal stored in buffers of the memory 124 is read by the display device 130. The codec 122 may store a decoded image signal in one of buffers in the buffer pool 230 represented as being in an unused state via the buffer list 220 and as being in a usable state via the buffer flag 210. Accordingly, it is possible to prevent the tearing error.

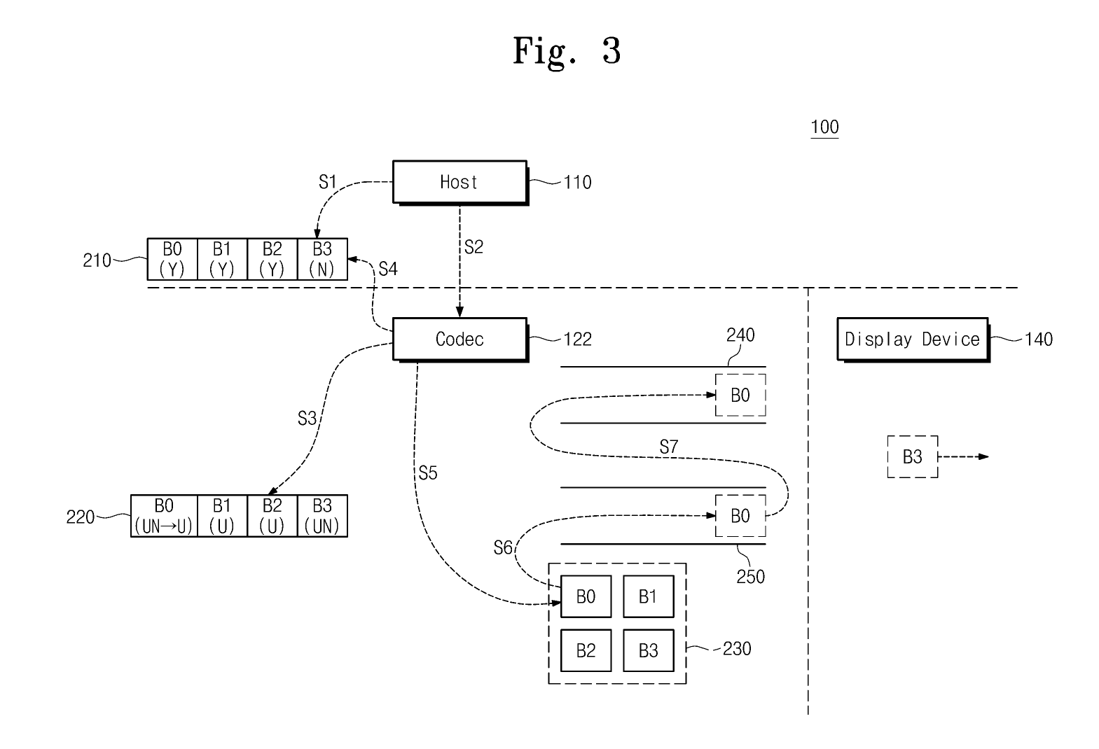

FIG. 3 is a diagram for describing a decoding method of an image processing system including an image signal decoding device according to an exemplary embodiment.

In FIG. 3, the first to fifth regions of a memory 124 in FIG. 2, that is, a buffer flag 210, a buffer list 220, a buffer pool 230, a display buffer list 240, and a DPB list 250 may be illustrated separately. In an exemplary embodiment, the buffer pool 230 may include four buffers B0, B1, B2, and B3. However, it is well understood that the number of buffers in the buffer pool 230 is not limited to four and is determined variously.

Referring to FIG. 3, in operation S1, a host 110 may store usable and not-available states Y and N of the buffers B0 to B3 in the buffer flag 210 of the memory 124. In the event that at least one of image signals stored in the buffers B0 to B3 of the buffer pool 230 is not read out by a display device 140, a flag bit corresponding to the buffer that is not read out may be set to a value corresponding to a not-available state.

In operation S2, the host 110 may request decoding on an image signal from the codec 122. In an exemplary embodiment, the host 110 may request frame-unit decoding from the codec 122. In operation S3, the codec 122 may select one of the buffers B0 to B3 of the buffer list 220 in response to a decoding request of the host 110. The codec 122 may select a buffer having an unused state UN of the buffers B0 to B3 in the buffer list 220. The buffer list 220 may store a usable state U or unused state UN of each of the buffers B0 to B3 of the buffer pool 230.

In an exemplary embodiment, it is assumed that the buffers B0 and B3 are set to an unused state UN and the codec 122 selects the buffer B3. In operation S4, the codec 122 may check a flag bit corresponding to the buffer B3 of the buffer flag 210. A flag bit corresponding to the buffer B3 of the buffer flag 210 may indicate a not-available state N. This means that a decoded image signal stored in the buffer B3 of the buffer pool 230 is not yet read by the display device 140.

The codec 122 may select the buffer B0 set to the unused state UN of the buffers B0 and B3 in the buffer list 220. Since a flag bit corresponding to the buffer B0 of the buffer flag 210 indicates a usable state Y, the codec 122 may decode an image signal requested from the host 110. At this time, the codec 122 may decode an image signal stored in a region of the memory 124 in FIG. 2 or an image signal directly provided from the host 110. In operation S5, the codec 122 may store the decoded image signal in the selected buffer B0, and may set the buffer B0 of the buffer list 220 so as to represent a usable state Y.

If an image signal stored in the buffer B0 is an image signal of a reference frame, in operation S6, the codec 122 may register the buffer B0 at the DPB list 250. In operation S7, the buffer B0 registered at the DPB list 250 may be registered at the display buffer list 240 at a display order. When a buffer registered at the display buffer list 240 exists, the codec 122 may inform the host 110 that a buffer registered at the display buffer list 240 exists.

Afterwards, the host 110 may control the display device 140 to read out an image signal from the buffer B0 in the buffer pool 230. Until the display device 140 reads out an image signal from the buffer B0 within the buffer pool 230, the host 110 may set a flag bit corresponding to the buffer B0 to a not-available state N.

The display device 140 may read image signals stored in the buffers B0 to B3 within the buffer pool 230 in response to the control of the host 110. In the event that the display device 140 does not process an image signal stored in the buffer B3 within the buffer pool 230, a flag bit corresponding to the buffer B3 may indicate a not-available state N.

After informing the host 110 of information of the buffer B0 registered at the display buffer list 240, the codec 122 may delete the buffer B0 from the display buffer list 240 and may configure the buffer list 220 with information indicating that the buffer B0 is at an unused state UN. Afterwards, a new decoding image signal may be stored in the buffer B0 of the buffer pool 230.

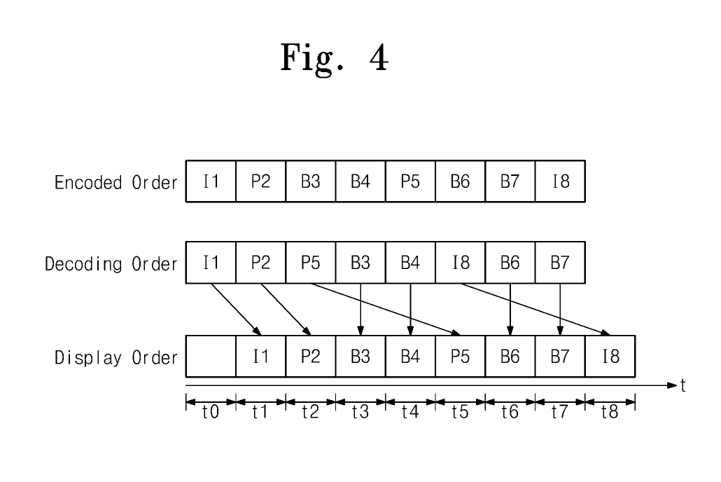

FIG. 4 is a diagram for describing a decoding order of a codec according to an exemplary embodiment.

Referring to FIG. 4, an encoded image stream may include an intra-frame (hereinafter, referred to as I-frame), a predicted frame (hereinafter, referred to as P-frame), and a bi-directional frame (hereinafter, referred to as B-frame). The I-frame may be encoded independently without referring to another frame. The P-frame may be encoded referring to a previous frame. The B-frame may predict referring to a previous frame as well as a frame which is to be displayed following a current frame. A decoded picture buffer (DPB) may be requested to decode the P-frame and the B-frame.

As illustrated in FIG. 4, an encoded image stream may include eight frames 11, P2, B3, B4, P5, B6, B7, and 18. If decoding on the I-frame I1 is ended, a buffer which the encoded image signal of the I-frame I1 is stored in will be registered at a display buffer list 240.

After informing the host 110 of information associated with a buffer storing the decoded image signal of the I-frame I1 registered at the display buffer list 240, the codec 122 may delete the buffer, which stores the I-frame I1, from the display buffer list 240. If the I-frame I1 is deleted, the codec 122 cannot decode a next P-frame P2. A reference frame to be referred at a next frame may be registered at the DPB list 250. For example, at t0, the I-frame I1 may be decoded, and a buffer storing an image signal of the I-frame I1 may be registered at the DPB list 250. At t1, the P-frame P2 may be decoded based upon the I-frame I1, and a buffer storing an image signal of the P-frame P2 may be registered at the DPB list 250. At this time, information associated with a buffer storing an image signal of the I-frame I1 may be sent to the display buffer list 240 from the DPB list 250. At t2, the P-frame P5 may be decoded, and a buffer storing an image signal of the P-frame P5 may be registered at the DPB list 250. Further, information associated with a buffer storing an image signal of the P-frame P2 may be sent to the display buffer list 240 from the DPB list 250. At t3, the B-frame B3 may be decoded, and a buffer storing an image signal of the B-frame B3 may be registered at the display buffer list 240. At t4, the B-frame B4 may be decoded, and a buffer storing an image signal of the B-frame B4 may be registered at the display buffer list 240. Afterwards, at t5, a buffer storing an image signal of the P-frame P5 registered at the DPB list 250 may be registered at the display buffer list 240. Accordingly, the display device 140 may display the B-frame B3, the B-frame B4, and the P-frame P5 in this order.

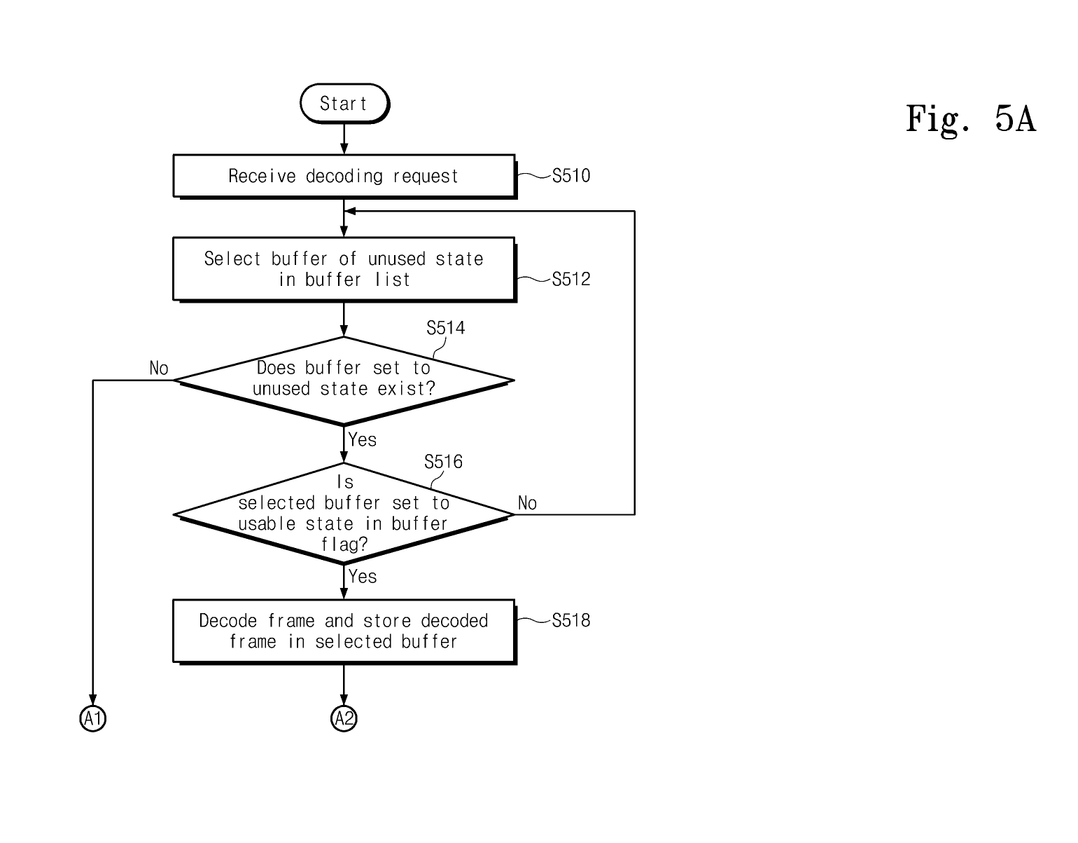

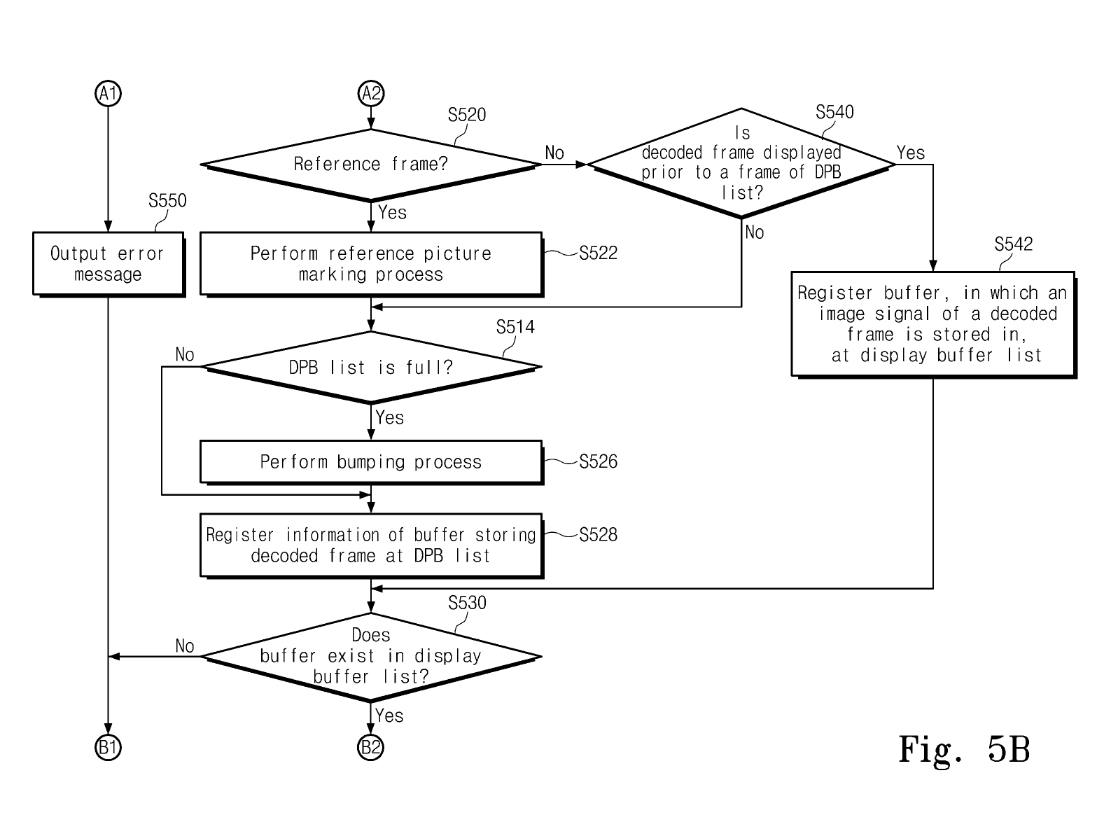

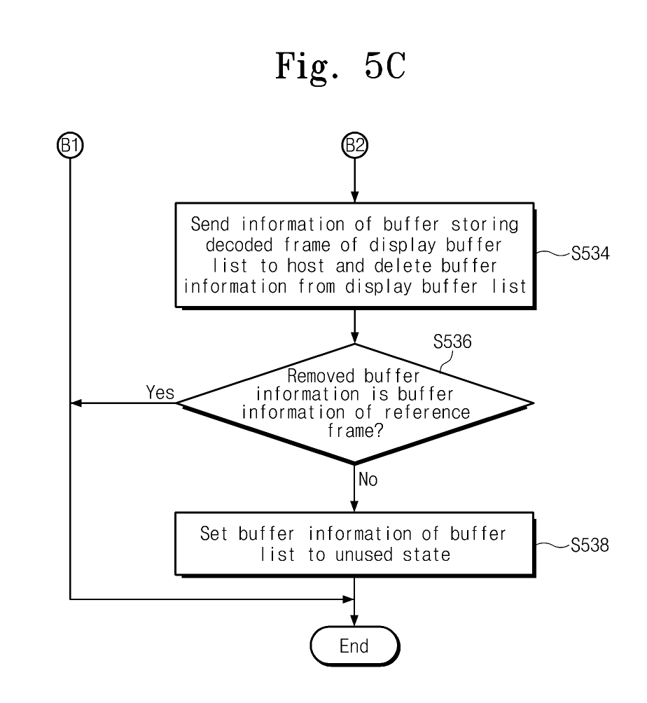

FIGS. 5A, 5B, and 5C are flowcharts for describing an image signal decoding method of a decoding device in FIG. 1.

Referring to FIGS. 1, 2, 5A, 5B, and 5C, a codec 122 may receive a decoding request from a host 110 (S510). The codec 122 may select one of buffers of a buffer list 220 set to an unused state UN (S512). If a buffer set to the unused state UN does not exist in the buffer list 220 (S514—No), the codec 122 may output an error message to the host 110 and may end the decoding operation (S550).

If a buffer set to the unused state UN exists in the buffer list 220 (S514—Yes), the codec 122 may select the buffer set to the unused state UN. If the selected buffer is not set to a usable state Y within a buffer flag 210 (S516—No), the codec 122 may select a new buffer set to the unused state UN of buffers of the buffer list 220. With the above description, there may be selected a buffer, which is set to an unused state Y within the buffer list 220 and to a usable state Y within the buffer flag 210, of buffers within the buffer pool 230 (S516—Yes). The codec 122 may decode an image signal within a frame requested from the host 110 and may store the decoded image signal in the selected buffer (S518). If a decoded frame is a reference frame (S520—Yes), the codec 122 may perform a reference picture marking process (S522).

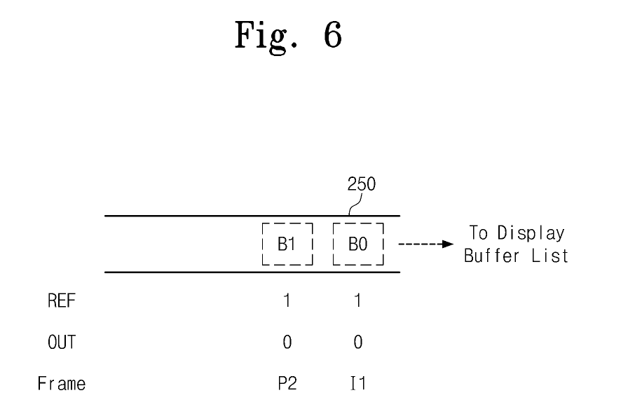

FIG. 6 is a diagram illustrating a decoded picture buffer list in FIG. 3 according to an exemplary embodiment.

Referring to FIG. 6, a reference picture marking process may comply with the MPEG-4 AVC standard and may include configuring a reference state value REF of a buffer registered at a DPB list 250 into ‘1’. The reference picture marking process may further include removing a buffer, which has a reference state value REF in the DPB list 250 being ‘1’ and has an output state value OUT being ‘1’, from the DPB list 250. The DPB list 250 may store not only a list of a decoded picture buffer (DPB) of buffers B0 to B3 within a buffer pool 230 in FIG. 3 but also reference and output state values REF and OUT corresponding to each DPB.

The reference state value REF may be set to ‘1’ when a frame stored in a corresponding buffer is referred by another frame and to ‘0’ when to refer a frame is ended. The output state value OUT may be set to ‘1’ when a buffer stored in the DPB list 250 is output to a display buffer list 240 and to ‘0’ when it is not yet output to the display buffer list 240.

For example, in the event that a buffer B0 in the buffer pool 230 stores an image signal of an I-frame I1 and a buffer B1 thereof stores an image signal of a P-frame P2, the buffer B0 in the DPB list 250 must be maintained until referring by a next P-frame P2 is ended, without deleting. As described above, the DPB list 250 may be used to maintain an image signal of a reference frame until referring by another frame is ended. However, since a size of the DPB list 250 is limited, a buffer having a reference state value REF being ‘0’ and an output state value OUT being ‘1’ may be removed from the DPB list 250. In a case where a buffer removed from the DPB list 250 exists, the removed buffer may be set to an unused state UN.

Referring again to FIGS. 5A, 5B, and 5C, if the DPB list 250 is full (S524—Yes), a codec 122 may perform a bumping process (S526). The bumping process may be made to make an empty space in the DPB list 250. During the bumping process, the codec 122 may output buffers set at the DPB list 250 to the display buffer list 240. The codec 122 may configure an output state value OUT in the DPB list corresponding to a buffer output to the display buffer list 240 from the DPB list 250 into ‘1’. The above-described bumping process can be performed in a manner defined by the H.264 standard.

If the DPB list 250 is not full (S524—No), the codec 122 may register a buffer, in which an image signal of a decoded reference frame is stored, at the DPB list 250, without the bumping process (S528).

The codec 122 may register a buffer, in which an image signal of a decoded frame is stored, at the display buffer list 240 (S542) when a decoded frame is not a reference frame (S520—No) and is displayed prior to a frame of the DPB list 250 (S540—Yes). This may be made in operations S520 and S540.

If a buffer registered at the display buffer list 240 exists (S530—Yes), the codec 122 may send buffer information to a host 110 and may delete a buffer registered at the display buffer list 240 (S534). If a buffer deleted from the display buffer list 240 is not a buffer storing an image signal of a reference frame (S536—No), the codec 122 may amend a buffer list 220 so as to be set to an unused state UN (S538).

The host 110 may set a flag bit, which corresponds to buffer information provided from the codec 122, of flag bits within the buffer flag 210 into a not-available state N. Afterwards, if a display device 140 reads an image signal stored in a corresponding buffer, a flag bit may be set to a usable stage Y.

With the above-described decoding method, although a buffer is set to an unused state UN at the buffer list 220, it is possible to prevent a new image signal from being overwritten at the buffer which is not read by the display device 140.

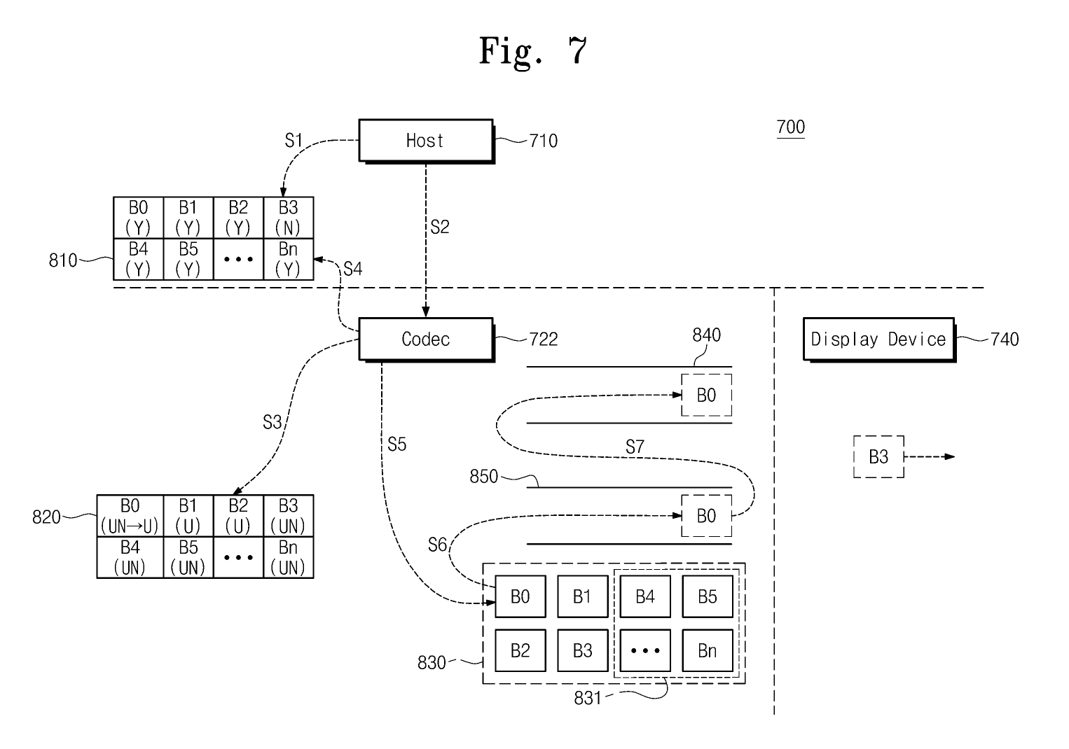

FIG. 7 is a diagram illustrating a decoding system according to another exemplary embodiment.

A decoding system 700 in FIG. 7 may be configured to be similar to that in FIG. 3 except that a buffer pool 830 further includes an extended buffer group 831 together with four buffers B0 to B3. The extended buffer group 831 may include a plurality of extended buffers B4 to Bn. The number of the extended buffers B4 to Bn in the extended buffer group 831 may be determined variously as occasion demands.

A buffer flag 810 may include flag bits indicating usable and not-available states Y and N of the buffers B0 to B3 as well as the extended buffers B4 to Bn of the buffer pool 830. Likewise, a buffer list 820 may include used and unused states U and UN of the buffers B0 to B3 as well as the extended buffers B4 to Bn of the buffer pool 830.

It is possible to minimize an error caused at a decoding operation by further providing the extended buffers B4 to Bn in the buffer pool 830. For example, the buffer pool 830 can be filled when an image signal decoded by a codec 722 is stored and then a display device 740 does not read the stored image signal. Alternatively, although an image signal of a reference frame is read by the display device 740, it must remain at the buffer pool 830. In the event that a series of image streams include many reference frames, the buffer pool 830 can be filled. It is possible to minimize an error caused at a decoding operation by increasing the number of buffers included in the buffer pool 830. If the buffer pool 830 includes the extended buffers B4 to Bn, the buffer flag 810 and the buffer list 820 can store usable and not-available states Y and N and used and unused states U and UN of the extended buffers B4 to Bn.

Accordingly, it is possible to manage buffers used to store and transfer images effectively.

The above-disclosed subject matter is to be considered illustrative, and not restrictive, and the appended claims are intended to cover all such modifications, enhancements, and other exemplary embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. An image signal decoding device comprising:
a memory comprising a first region storing a buffer flag, a second region storing a buffer list, and a third region formed of a plurality of buffers each storing a decoded image signal; and
a codec configured to decode an image signal in response to a decoding request from a host, and to store the decoded image signal in one of the plurality of buffers,
wherein the buffer flag indicates a usable or not-available state of each of the plurality of buffers;
wherein the buffer list indicates a used or unused state of each of the plurality of buffers; and
wherein the codec stores the decoded image signal in a buffer which is set to the unused state in the buffer list and to a usable state in the buffer flag.

2. The image signal decoding device of claim 1, wherein the codec selects a buffer set to the unused state in the buffer list in response to the decoding request and stores the decoded image signal in the selected buffer when the selected buffer is set to the usable state in the buffer flag.

3. The image signal decoding device of claim 2, wherein the codec selects a new buffer set to the unused state in the buffer list when the selected buffer is set to a not-available state in the buffer flag and stores the decoded image signal in the new buffer when the new buffer is set to the usable state in the buffer flag.

4. The image signal decoding device of claim 1, wherein the memory further comprises:
a fourth region configured to store a display buffer list indicating a display order of buffers, each storing the decoded image signal, of the plurality of buffers; and
a fifth region configured to store a decoded picture buffer (DPB) list indicating a buffer, storing an image signal of a reference frame, of the plurality of buffers each storing the decoded image signal.

5. The image signal decoding device of claim 4, wherein the codec stores the decoded image signal in the selected buffer and registers information of the selected buffer at the DPB list when the decoded image signal is an image signal of the reference frame.

6. The image signal decoding device of claim 4, wherein a display order of buffers storing the decoded image signal stored in the display buffer list is deleted in a first-in first-out manner, and the codec sets a buffer corresponding to the deleted display order in the buffer list to an unused state.

7. The image signal decoding device of claim 1, wherein the buffer flag stored in the first region of the memory is set by the host.

8. An image signal decoding method of a decoding device, the method comprising:
receiving a decoding request from a host;
selecting a buffer set to an unused state in a buffer list in response to the decoding request;
determining whether the selected buffer is set to a usable state in a buffer flag;
decoding an image signal when it is determined that the selected buffer is set to a usable state in the buffer flag; and
storing the decoded image signal in the selected buffer.

9. The image signal decoding method of claim 8, further comprising:
selecting a new buffer set to an unused state in the buffer list when the selected buffer is set to a not-available state in the buffer flag; and
storing the decoded image signal in the new buffer when the new buffer is set to the usable state in the buffer flag.

10. The image signal decoding method of claim 8, wherein the memory comprises a first region storing the buffer flag, a second region storing the buffer list, and a third region which is a buffer.

11. The image signal decoding method of claim 10, wherein the memory further comprises:
a fourth region configured to store a display buffer list indicating a display order of buffers, each storing the decoded image signal, of the plurality of buffers; and
a fifth region configured to store a decoded picture buffer (DPB) list indicating a buffer, storing an image signal of a reference frame, of the plurality of buffers each storing the decoded image signal.

12. The image signal decoding method of claim 11, further comprising:
registering information of the selected buffer at the DPB list when the decoded image signal is an image signal of the reference frame after storing of the decoded image signal in the selected buffer.

13. The image signal decoding method of claim 11, further comprising:
providing a host with information of a buffer storing the decoded image signal according to a display order of the buffers stored in the buffer list.

14. The image signal decoding method of claim 13, further comprising:
after information of a buffer storing the decoded image signal is provided to the host, setting the buffer provided to the host at the buffer list as an unused state.

15. An image signal decoding system comprising:
a memory comprising a first region storing a buffer flag, a second region storing a buffer list, and a third region formed of a plurality of buffers each storing a decoded image signal;
a codec configured to decode an image signal in response to a decoding request from a host and to store the decoded image signal in one of the plurality of buffers; and
a display device configured to display the decoded image signal,
wherein the buffer flag indicates a usable or not-available state of each of the plurality of buffers and the buffer list indicates a used or unused state of each of the plurality of buffers.

16. The image signal decoding system of claim 15, wherein the codec stores the decoded image signal in a buffer which is set to the unused state in the buffer list and to a usable state in the buffer flag.

17. The image signal decoding system of claim 15, wherein the codec selects a buffer set to the unused state in the buffer list in response to the decoding request and stores the decoded image signal in the selected buffer when the selected buffer is set to the usable state in the buffer flag.

18. The image signal decoding system of claim 17, wherein the codec selects a new buffer set to the unused state in the buffer list when the selected buffer is set to the not-available state in the buffer flag and stores the decoded image signal in the new buffer when the new buffer is set to the usable state in the buffer flag.

19. The image signal decoding system of claim 15, wherein the memory further comprises:
a fourth region configured to store a display buffer list indicating a display order of buffers, each storing the decoded image signal, of the plurality of buffers; and
a fifth region configured to store a decoded picture buffer (DPB) list indicating a buffer, storing an image signal of a reference frame, of the plurality of buffers each storing the decoded image signal.

20. The image signal decoding system of claim 15, wherein the codec continuously decodes a plurality of frames in response to the decoding request from the host, and the display device sequentially displays decoded image signals according to a frame order.
